(19) United States
(12) Patent Application Publication
(10) Pub. No.: US 2008/0000591 A1
(43) Pub. Date: Jan. 3, 2008

(54) Sealing jaw with a trianglular-like profiled passive jaw

(75) Inventor: Roland Basque, Brossard (CA)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(73) Assignee: Glopak Inc., Montreal (CA)

(21) Appl. No.: 11/516,923

(22) Filed: Sep. 6, 2006

(30) Foreign Application Priority Data
Jun. 29, 2006 (CA) 2551221

(51) Int. Cl. B30B 15/34

(52) U.S. Cl. 156/583.1

(57) ABSTRACT

A sealing jaw assembly is comprised of a passive jaw pad and an active ceramic jaw adapted to conduct a heating current for generating a sealing temperature in a profiled sealing head to form a seal in a polyolefin film material compressed between the jaws. The sealing head of the passive jaw has a triangular profile defining opposed inclined side walls and a joint. The side walls provide variable pressure and the joint defines a cutting edge. The inclined side walls are disposed at selected angles to form an angled seal profile to enhance the quality of the seal formed in the polyolefin film.

### TECHNICAL FIELD

The present invention relates to a sealing jaw assembly for shaping a seal in polyethylene-based films to provide a seal of quality.

### BACKGROUND ART

Typically, sealing jaws used in VFFS (Vertical Form, Fill and Seal) machinery comprise a passive jaw (the opposing jaw which receives no electric current) designed using a soft rubber or silicone material and is shaped flat to receive the sealing and cutting edge of the heating element, which is loaded onto the active jaw. The selection process for this silicone pad has been to select one that is readily available in dimensions already known and commercialized in the industry.

In the case of a known jaw used for high-speed, low-maintenance commercial applications developed by Glopak Inc., the silicone pad must have the “cut” shape portion contained in it, since the active jaw now provides only a flat, smooth surface.

The cut portion, however, is also made to be a generic component that should typically be useful in a variety of applications, and can be used with a variety of different film types.

### SUMMARY OF INVENTION

According to a broad aspect of the present invention there is provided a sealing jaw assembly which comprises an active jaw and a shaped passive jaw. The active jaw is provided with means to conduct a heating current for generating a sealing temperature when the jaws are brought into compression with a polyolefin film material compressed between the jaws. The sealing head of the passive jaw has a triangular-like profile defining opposed inclined side walls and a projecting point. The side walls provide variable pressure and the point defines a cutting edge for the seal being formed. The inclined side walls are disposed at selected angles and shapes to form an angled seal profile to enhance the quality of the seal formed in the polyolefin film material.

### BRIEF DESCRIPTION OF DRAWINGS

A preferred embodiment of the present invention will now be described with reference to the accompanying drawings in which:

FIG. 1 is a schematic side view showing the geometry of the active ceramic jaw and the profiled passive jaw together with the profile of the seal formed by superimposed sheets of polyolefin film formed between the jaws;

FIG. 2 is a view similar to FIG. 1 but showing a different sealing passive jaw profile;

FIG. 3 is a view similar to FIG. 1 but showing a still further different sealing passage jaw profile;

FIG. 4 is a view similar to FIG. 1 but showing a passive jaw profile having opposed stepped side walls;

FIG. 5 is a view similar to FIG. 4 but wherein the step profile is at a different angle;

FIG. 6 is a view similar to FIG. 4 but showing a still further angle of the step profile of the passive sealing jaw; and

FIGS. 7A and 7B show different shapes of the side walls of the passive jaw.

### DESCRIPTION OF PREFERRED EMBODIMENTS

A generic silicone pad, when used with the Glopak jaw mentioned above, provides adequate performance. However, it can be improved substantially, and the improvement can be financially justified, if it is applied in existing industry applications where such a process is useful.

In the case of VFFS (Vertical Form, Fill and Seal) filling machinery, for example, and in the case of the manufacture of pouches destined to a retail market, the silicone pad can be fine-tuned to provide accurate sealing results since the pad is designed specifically for this particular use. It may be said also that this same pad would be inappropriate in other applications.

The pad of such sealing jaws must be designed to provide ideal sealing results by understanding a) the geometry and dimensions that is ideal for the film being used, b) the mechanical operation and detail which provides the sealing system and c) the conditions that will exist during the sealing process for the active jaw inherent to the process. A number of assumptions must be made. The mechanical and electrical systems involved in the process must be in good working order and provide the level of accuracy and speed required by the process.

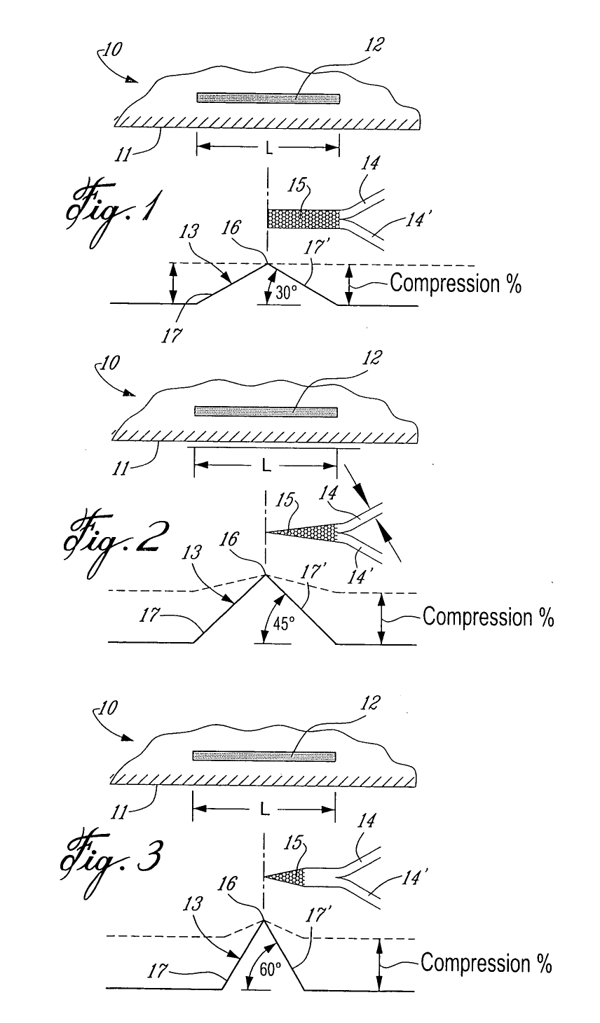

With reference to FIGS. 1 to 6, the jaw assembly of the present invention comprises an active jaw 10 having a sealing surface 11 which is flat. A heating element 12, a steel alloy of known width, provides heat energy in sufficient quantity to the sealing surface 11. The active jaw has a protective ceramic layer defining the sealing jaw surface 11.

The passive jaw 13 is a pad of soft rubber, 60 to 70 duro compound, and modified to provide an ideal sealing geometry. From the drawings, it can be established that the width L is equivalent to the width of the passive jaw 13. During sealing, this width L provides ample heat energy and the films 14 and 14′ are compressed between the active and passive jaws and are heated in a molten state in the area (L) defined by the width of the shaped passive jaw 13. Only one side of the seal 15 is herein illustrated having been cut by the projecting point 16 of the shaped passive jaw 13.

The cutting edge or point 16 is disposed at the center of the area (L). The passive jaw 13 has a triangular-like profile with opposed inclined side walls 17 and 17′. The point 16 of the triangular shape provides the cutting edge to sever the seal in two parts, only one part 15 being shown herein, and each inclined side wall provides pressure in the sealing zone (L), thereby sealing the films using pressure and temperature.

FIGS. 1 to 3 show that the geometry of the seal can be adjusted and shaped by altering the included angles of the side walls 17 and 17′ and the overall height of this triangular shape. FIGS. 1 to 3 show three possible angles of 30°, 45° and 60°. Combining this geometry with other known parameters, such as the actual hardness of the silicone pad, the mechanical pressure applied to it during sealing and the gauge(s) of the films being sealed, the % compression (% C) can be calculated.

Following this, the ideal geometry of the passive jaw 13 can be achieved. The ideal seal geometry must be calculated using scientific means. However, regardless of what this geometry is, an appropriate profile can be developed and the silicone pad can be designed to meet precisely the application.

Preferably, the sealing jaw is used for sealing superimposed polyolefin films, such as films 14 and 14′ herein illustrated, having gauges in the range of 1.5 mil to 4 mil thickness. The passive jaw which is profiled for the specific polyolefin film so that the shape of the seal 15 has a crucial impact on the quality of the seal whereby to improve seal quality for specific film material used for specific pouches formed.

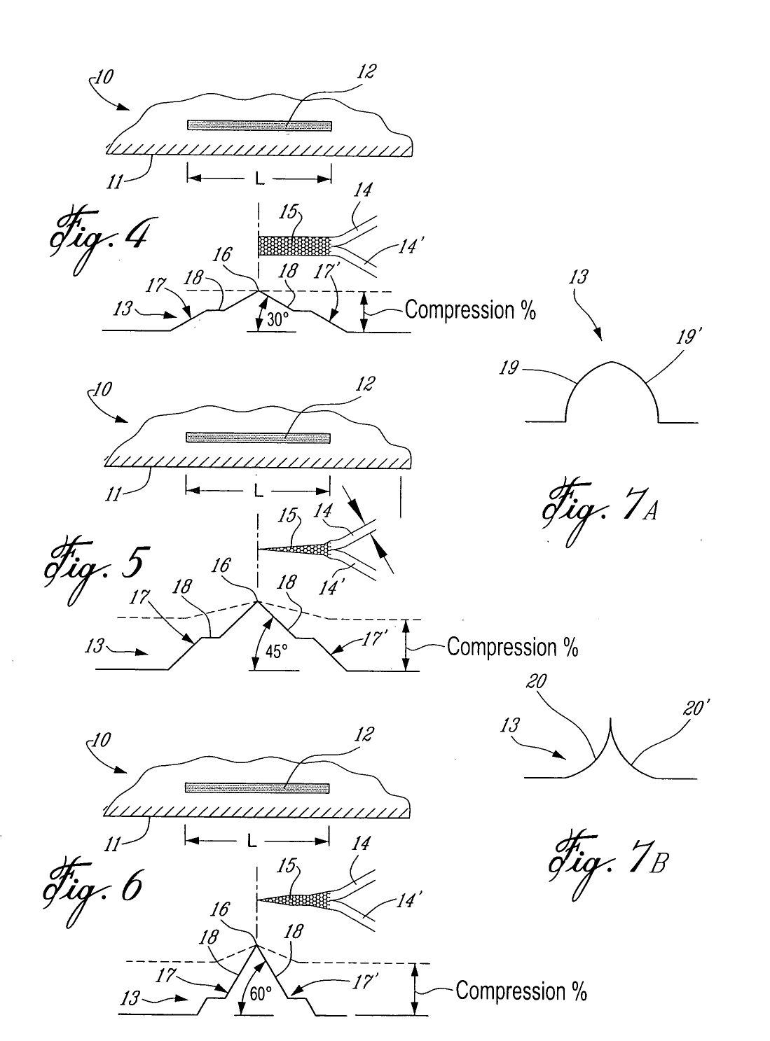

FIGS. 4, 5 and 6 illustrate the sealing head 13 of the passive jaw shaped similar to FIGS. 1 to 3 but wherein the side walls 17 and 17′ on each side of the point 16′, have a double-angled profile 18, that is to say a stepped profile. This permits again the modification of the geometry of the seals 15 as illustrated in FIGS. 5 and 6. It is pointed out that although the angles of the side walls 17 and 17′ of the passive jaw 13 are shown disposed at angles of 30°, 45° and 60°, it is not intended to restrict the present invention to those specific angles and other workable angles are envisaged. It is also envisaged, as illustrated in FIGS. 7A and 7B, that the side walls can have a variety of shapes. As shown in FIG. 7A, the opposed side walls 19 and 19′ are convexly shaped and in FIG. 7 the side walls 20 and 20′ are concavely shaped.

The ideal sealing geometry can be investigated and determined using a scientific approach, trial and error and data gathering. This exercise is necessary to determine the precise angles, % compression and L values. Existing seal quality theory has evolved around film chemical composition which is a crucial sealing factor.

However, for all films to be sealed, it must be concluded that some physical mechanical seal geometry is better, ideal in fact, and anything less is a compromise. The seal geometry is a factor relative to the film's gauge, and the dimensional factors of the width of the wall. Seal quality is a factor of seal geometry, film composition, homogeneity of the film composition in the seal zone, and other factors utilized during a sealing process.

Testing of this novel concept, without generating scientific data but instead making repeated observations on a prototype assembly, has shown that seal geometry definitely has a significant importance on seal quality.

It is therefore within the ambit of the present invention to cover any obvious modifications of the preferred embodiments described and illustrated herein provided such embodiments fall within the scope of the appended claims.

I claim:

1. A sealing jaw assembly comprising an active jaw and a shaped passive jaw, said active jaw having means to conduct a heating current for generating a sealing temperature when said jaws are brought into compression with a polyolefin film material compressed between said jaws, said sealing head of said passive jaw having a triangular-like profile defining opposed inclined side walls and a projecting point, said side walls providing variable pressure and said point defining a cutting edge for a seal being formed, said inclined side walls being disposed at selected angles and shapes to form an angled seal profile to enhance the quality of the seal formed in said polyolefin film material.

2. A sealing jaw assembly as claimed in claim 1 wherein said polyolefin has a gauge in the range of 1.5 mil to 4 mil.

3. A sealing jaw assembly as claimed in claim 1 wherein said sealing head side walls are straight, inclined side walls each disposed at a selected common angle of 30°, 45° or 60°.

4. A sealing jaw assembly as claimed in claim 1 wherein said sealing head side walls are stepped side walls to form a double-angled seal profile.

5. A sealing jaw assembly as claimed in claim 1 wherein said side walls are symmetrically shaped.

6. A sealing jaw assembly as claimed in claim 1 wherein said side walls are curved side walls of concave or convex shape.

7. A sealing jaw assembly as claimed in claim 1 wherein said active jaw has a ceramic protective layer defining a flat sealing face.

8. A sealing jaw assembly as claimed in claim 7 wherein said means to conduct a heating current is an alloy steel bar of predetermined width substantially equivalent to the width of a seal to be formed in said polyolefin film material.

9. A sealing jaw assembly as claimed in claim 8 wherein said film material is constituted by superimposed film sheets.
